(19) United States
(12) Patent Application Publication
(10) Pub. No.: US 2014/0278525 A1
(43) Pub. Date: Sep. 18, 2014

(54) METHOD AND APPARATUS FOR PROVIDING IMPROVED SEARCHING OF MEDICAL RECORDS

(71) Applicant: MCKESSON FINANCIAL HOLDINGS, Hamilton (BM)

(72) Inventor: Charles Curran, Pinole, CA (US)

(73) Assignee: MCKESSON FINANCIAL HOLDINGS, Hamilton (BM)

(21) Appl. No.: 13/800,406

(22) Filed: Mar. 13, 2013

(51) Int. Cl. G06F 19/00

(52) U.S. Cl. CPC G06F 19/322
USPC 705/3

(57) ABSTRACT

A method, apparatus and computer program product are therefore provided in order to provide improved searching of medical records. In this regard, the method, apparatus, and computer program product may provide a network infrastructure that gathers search analytics for medical records searches performed across a plurality of record keepers. Embodiments may identify correlations between querying record keepers and record keepers that provide records that are properly responsive to queries from the querying record keeper. For example, embodiments may derive search analytics related to which record keepers typically provide correct record results in response to a query from a particular record keeper, and these identified record keepers may be specifically queried in response to future requests received from the querying record keeper.

### TECHNOLOGICAL FIELD

Example embodiments of the present invention relates generally to health information systems, and, more particularly, to a method and apparatus for exchanging medical record information using a health information infrastructure.

### BACKGROUND

Advances in technology have led to the ability to access and share information more easily than ever before. It is increasingly common for individuals and companies to store their information in an electronic format, providing for easy sharing and archiving, and reducing the need for physical records. In particular, the ability to store medical records in an electronic format has the potential to revolutionize patient care by facilitating easy access to patient information among medical practitioners, users, healthcare organizations, and the like. However, the unique requirements for maintenance of electronic medical records have created challenges to implementation of electronic record storage and sharing systems.

One implementation of an electronic record storage and sharing system is the health information exchange. These exchanges provide for the ability to share a patient's medical records across the various health organizations and practitioner offices that participate in the exchange. Sharing of patient records in this manner allows for medical practitioners at a first institution to easily and efficiently determine what care and treatment the patient has received from other institutions. However, as more and more record keepers add their records to a particular exchange, the likelihood of incorrect matches increases due to the increased likelihood that different patients share the same identifying data. For example an exchange including several regional hospitals may include records for numerous patients with the same names and birthdates. Attempting to identify appropriate records based solely on these characteristics may lead to false positives simply due to a large sample size. In some circumstances, these records may even have additional commonalities, such as the same last four social security number digits. Additionally, as more records and record keepers are added to the system, additional latency is introduced to allow for time to receive responses from all record keepers.

### BRIEF SUMMARY

A method, apparatus and computer program product are therefore provided according to an example embodiment of the present invention in order to provide improved searching of medical records. In this regard, the method, apparatus, and computer program product of an example embodiment may provide a network infrastructure that gathers search analytics for medical records searches performed across a plurality of record keepers. Embodiments may identify correlations between querying record keepers and record keepers that provide records that are properly responsive to queries from the querying record keeper. For example, embodiments may derive search analytics related to which record keepers typically provide correct record results in response to a query from a particular record keeper, and these identified record keepers may be specifically queried in response to future requests received from the querying record keeper.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment of the present invention;

FIG. 2 is a block diagram of an example of a network infrastructure in accordance with an example embodiment of the present invention;

FIG. 3 is a flow diagram of an example of a method for performing a medical record search in accordance with an example embodiment of the present invention;

FIG. 4 is a flow diagram of another example of a method for performing a medical record search in accordance with an example embodiment of the present invention; and

FIG. 5 is a block diagram depicting links between a patient identity specified within a records request and one or more medical records in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

A method, apparatus and computer program product are provided in accordance with an example embodiment of the present invention in order to provide improved searching of medical records. In this regard, a method, apparatus and computer program product of an example embodiment may process health record queries from one or more record keepers. These health record queries may include requests to view, access, modify, add, or delete medical records maintained by a medical records system. For example, the health record requests may include a request from a first record keeper to access medical records stored on other record keeper systems in order to obtain records associated with a particular patient. These queries may further include information about the querying record keeper, such as the identity of the record keeper, the record keeper's address, or location, the record keeper's specialty, or the like. Queries may be received and processed by a search provider implementing an Application Programming Interface (API) to send and receive queries. In some embodiments, the search provider may monitor queries and whether previously provided record results were properly responsive to queries to derive search analytics. These search analytics may be used to improve search performance and reduce search latency by targeting particular record keepers and identifying anomalous results.

The term “record keeper” should be understood generally to refer to any individual or group that may request or provide access to medical records. This may include, but is not limited to, hospitals, physicians, patients, nurses, insurance companies, archives, government agencies, healthcare administrators, or any other provider, payer, or computer system maintained or operated by any of these entities. The term “record keeper” does not require or imply that the entity necessarily has record storage capabilities or will otherwise maintain any received records, although said entity may in fact possess such capabilities. Rather, this term is used merely to indicate the ability to participate in the exchange of medical record information.

FIG. 1 illustrates a block diagram of an apparatus 102 in accordance with some example embodiments. The apparatus 102 may be any computing device capable of functioning in a health information infrastructure, including desktop or laptop computers, mobile devices, tablet computers, servers, or the like. In some particular embodiments, the apparatus 102 may be configured to provide access to medical records via a user portal. For example, the apparatus 102 may be implemented on a computing device that may be configured to receive a patient identity, and to access and display records associated with the patient identity via a display. Additionally or alternatively, the apparatus 102 may be configured to provide a health information system operable to receive and process medical records queries as described herein. The apparatus 102 may be configured to function as a search provider to facilitate the processing of medical record queries and to derive analytics for the purpose of providing improved search results. Accordingly, it will be appreciated that the apparatus 102 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The apparatus 102 may include or otherwise be in communication with processing circuitry 110 that is configurable to perform actions in accordance with one or more example embodiments disclosed herein. In this regard, the processing circuitry 110 may be configured to perform and/or control performance of one or more functionalities of the apparatus 102 (e.g., functionalities of a computing device on which the apparatus 102 may be implemented) in accordance with various example embodiments, and thus may provide means for performing functionalities of the apparatus 102 (e.g., functionalities of a computing device on which the apparatus 102 may be implemented) in accordance with various example embodiments. The processing circuitry 110 may be configured to perform data processing, application execution and/or other processing and management services according to one or more example embodiments. In some embodiments, the apparatus 102 or a portion(s) or component(s) thereof, such as the processing circuitry 110, may be embodied as or comprise a chip or chip set. In other words, the apparatus 102 or the processing circuitry 110 may comprise one or more physical packages (e.g., chips) including materials, components and/or wires on a structural assembly (e.g., a baseboard). The apparatus 102 or the processing circuitry 110 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 110 may include a processor 112 and, in some embodiments, such as that illustrated in FIG. 1, may further include memory 114. The processing circuitry 110 may be in communication with or otherwise control a user interface 116 and/or a communication interface 118. As such, the processing circuitry 110 may be embodied as a circuit chip (e.g., an integrated circuit chip) configured (e.g., with hardware, software or a combination of hardware and software) to perform operations described herein.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 112 may comprise a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In some example embodiments, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA or the like, the processor 112 may be specifically configured hardware for conducting the operations described herein. Alternatively, as another example, when the processor 112 is embodied as an executor of software instructions, the instructions may specifically configure the processor 112 to perform one or more operations described herein.

In some example embodiments, the memory 114 may include one or more non-transitory memory devices such as, for example, volatile and/or non-volatile memory that may be either fixed or removable. In this regard, the memory 114 may comprise a non-transitory computer-readable storage medium. It will be appreciated that while the memory 114 is illustrated as a single memory, the memory 114 may comprise a plurality of memories. The plurality of memories may be embodied on a single computing device or may be distributed across a plurality of computing devices collectively configured to function as the apparatus 102. The memory 114 may be configured to store information, data, applications, instructions and/or the like for enabling the apparatus 102 to carry out various functions in accordance with one or more example embodiments. For example, the memory 114 may be configured to buffer input data for processing by the processor 112. Additionally or alternatively, the memory 114 may be configured to store instructions for execution by the processor 112. As yet another alternative, the memory 114 may include one or more databases that may store a variety of files, contents or data sets. Among the contents of the memory 114, applications may be stored for execution by the processor 112 in order to carry out the functionality associated with each respective application. In some cases, the memory 114 may be in communication with one or more of the processor 112, user interface 116, or communication interface 118 via a bus or buses for passing information among components of the apparatus 102.

The user interface 116 may be in communication with the processing circuitry 110 to receive an indication of a user input at the user interface 116 and/or to provide an audible, visual, mechanical or other output to the user. As such, the user interface 116 may include, for example, a keyboard, a mouse, a joystick, a display, a touch screen display, a microphone, a speaker, a Light Emitting Diode (LED), a lighting device, an electronic sensor for capturing human body movements, and/or other input/output mechanisms. In embodiments in which the apparatus 102 is implemented on a server, aspects of the user interface 116 may be limited, or the user interface 116 may even be eliminated. For example, the apparatus 102 may act as a server or host device, with a user interface provided by a client application.

The communication interface 118 may include one or more interface mechanisms for enabling communication with other devices and/or networks. In some cases, the communication interface 118 may be any means such as a device or circuitry embodied in either hardware, or a combination of hardware and software that is configured to receive and/or transmit data from/to a network and/or any other device or module in communication with the processing circuitry 110. By way of example, the communication interface 118 may be configured to enable the apparatus 102 to communicate with another computing device via a wireless network, such as a wireless local area network (WLAN), cellular network, and/or the like. Additionally or alternatively, the communication interface 118 may be configured to enable the apparatus 102 to communicate with another computing device via a wireline network. In some example embodiments, the communication interface 118 may be configured to enable communication between the apparatus 102 and one or more further computing devices via the internet. Accordingly, the communication interface 118 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

FIG. 2 is a block diagram of an example network infrastructure 200 in accordance with example embodiments of the present invention. The example network infrastructure 200 includes a search provider 202 in communication with one or more medical record keepers 204, 206, 208. The search provider 202 functions to implement searching, retrieval, and/or access to medical records maintained by the medical record keepers 204, 206, and 208. The search provider 202 may provide the ability to search records maintained by each record keeper to identify medical records associated with a particular patient or patients identified in a search query. For example, the search provider 202 may receive a records query from a first record keeper 204, and propagate the records query to additional record keepers 206, 208.

The search provider 202 may function to provide an exchange of medical records data maintained by a plurality of medical record keepers. The example network infrastructure 200 depicts three medical record keepers, record keeper A 204, record keeper B 206, and record keeper C 208. For example, the record keepers may include healthcare organizations such as hospitals, physician's offices, medical imaging facilities, or the like. Record keepers may provide access to medical records to the health information gateway 202 and thus other record keepers for any particular reason in order to provide better access to data and clinical outcomes to patients, or for any other appropriate reason. The health information gateway 202 may thus provide an interface for aggregation and searching of medical records from the associated record keepers. Although the example network infrastructure 200 depicts the medical records as maintained in separate datastores 210, 212, 214 associated with the individual record keepers 204, 206, 208, the medical records may also be maintained in a central store accessible by the health information gateway 210, or in a cloud storage environment accessible to one or more of the health information gateway 210 or the record keepers 204, 206, 208.

The record keepers 204, 206, 208 may access the health information gateway 210 via a portal interface or application programming interface (API). For example, each record keeper may implement one or more applications for facilitating access to medical records information. These applications may implement an API to send and receive requests for medical records to the search provider 202. Additionally or alternatively, the search provider 202 may provide direct access via a portal application (e.g., a web browser interface).

In some embodiments, the search provider 202 may select particular record keepers for propagation of the query. For example, the search provider 202 may identify particular record keepers as the most likely record keepers to have valid data responsive to a search query, and the query may be propagated specifically to these record keepers. Additionally or alternatively, the record query may be propagated to all record keepers or a different subset of record keepers, but record responses received from the most likely record keepers may receive preferential treatment, or results may not be provided to the querying record keeper until results have been received from the most likely record keepers. Example methods for performing medical record search operations by identifying particular record keepers are described further below with respect to FIGS. 3-4.

The search provider 202 may function to identify medical records associated with a particular patient specified in a record query. However, medical records may not always be indexed according to a unique patient identifier that is available to all record keepers. For example, each record keeper may assign a separate unique account number or patient identifier to records for a particular patient, and this unique value may not be known to other record keepers. In such cases, record keepers may not have a way to ensure that only requests referring to a particular patient are returned, as other patients may share identifying attributes in common with the patient associated with the record query. As an example, two patients may have the same first and last names, middle initial, and birthdate. A search provider that only searches based on these attributes might return records for both patients. As such, the search provider may include measures to differentiate and/or disambiguate patients that share one or more attributes. Furthermore, records queries may include sending separate records requests to multiple record keepers. The search provider and individual record keepers may not be equipped to handle a large volume of record requests, such that querying every record keeper may introduce significant latency in receiving a response to the record query. As such, the search provider 202 may implement procedures to reduce the number of record keepers queried, or to prioritize records requests from particular record keepers.

Embodiments may thus provide the search provider 202 with the ability to track certain attributes associated with records queries to improve the speed and quality of record search operations. These embodiments may include methods for determining which record keepers are most likely to have access to records that are responsive to a record query received from a particular record keeper. For example, patients may tend to visit medical providers within a certain radius of one another. As such, if a record query is received from a medical provider, the search provider 202 may examine records associated with other medical providers in the same geographic region as the querying medical provider. Additionally or alternatively, the querying medical provider may be associated with one or more insurance plans. Since patients tend to stay within their insurance network when seeking medical care, the search provider 202 may examine medical records for other providers within the insurance network.

When returning results to these search operations, the search provider 202 may further gather data as to whether the search results provided were correct. For example, selecting a particular medical record from a results window may notify the search provider 202 that the record was of interest to the user, which may be indicative of a result that is accurately associated with the patient for which the user had initiated the request. This notification may be included as part of a record selection or download operation. For example, the user may indicate to the search provider that they wish to view a particular record, and the same interaction may cause storage of the accuracy of the search result. Additionally or alternatively, the user may invoke a separate interface control to indicate whether a medical record was correct or not. For example, after viewing the details of the record, the user may be presented with an interface allowing the user to select whether the record was correct, since it may not be possible for the user to determine whether the record was for the correct user until after reviewing the record in detail.

Data as to whether a record result of the search operation was correct may be stored in a set of search analytics 216. These search analytics 216 may be used to improve the quality of future searches by identifying correlations between record queries and their correct results. For example, the search analytics 216 may identify that a particular hospital frequently receives valid record results from a particular subset of record keepers. Such a case may be indicative that patients that frequent the particular hospital also frequent each of the particular subset of record keepers. As such, these particular record keepers may be prioritized for future queries received from the particular hospital, and results received from these record keepers may be identified within the search results as “likely” correct results. In some embodiments, the search operation may be directed to the particular record keepers before searching other, less-likely record keepers, and results may be provided to the user as soon as the query is processed by the likely record keepers. In some embodiments, less-likely record keepers may not be searched until after the likely record keepers process the query, or other prioritization schemes may be employed. For example, less-likely record keepers may not be searched at all unless the likely record keepers fail to return any valid results.

As the body of search analytics data 216 grows, matures, and is analyzed over numerous search operations, various reports may be generated and used to improve search operations and provide users of the system with data. The search analytics 216 may identify patterns in how patients choose to obtain services from different providers, and these analytics may be used to both improve search results (e.g., to identify additional record keepers which may be worth clustering together for searching for patient records) and to improve efficiency and care offered by the record keepers. For example, hospitals may derive value from reports indicating which other providers their patients routinely visit, reports identifying patterns in types of facilities visited after visiting certain other types of facilities (e.g., providers at a practice consistently sending their patients to one hospital's lab over another), or reports identifying patients attempting to illegally obtain drugs from different facilities. Additionally or alternatively, payers may benefit from reports providing a full and accurate accounting of group members that have participated in an accountable care organization based on where patients in a defined area go for treatment. For example, a payer may desire to know that patients in a first zip code consistently visit a particular hospital or specialist, or that patients in a particular zip code frequently cross over multiple health systems.

In order to facilitate data gathering and correlation to improve search results, record queries received by the search provider may be associated with particular metadata. For example, in addition to information describing the patient, each query may identify the provider, patient, payer, or the like that initiated the query, the geographic location of the record keeper, whether the record request is associated with an in-patient or out-patient visit, a type of medical specialization associated with the record keeper, insurance affiliations for the record keeper, and/or the like. Likewise, results received in response to the query may be associated with metadata identifying the record keeper that provided the result. This information may be processed and analyzed as part of the search analytics 216 to identify correlations. For example, the search provider 202 may employ a machine learning algorithm that dynamically adjusts the weights accorded to metadata associations between record keepers when calculating which record keepers should be associated with one another for search operations. In some embodiments, this metadata may be provided by the record keeper during a registration or account creation operation, such that the metadata may be looked up later by extracting a record keeper identifier associated with a record query (e.g., a user account identifier included in the query, an Internet Protocol address associated with the query, or the like) and looking up the metadata associated with the record keeper identifier.

The results of a medical records query may be provided to the querying record keeper as a series of links to particular records. As described above, these results may include additional context information to assist the record keeper with making an informed choice for which records to access.

FIG. 3 is a flow diagram of an example of a method 300 for performing a medical record search in accordance with an example embodiment of the present invention. The method 300 may be operable to determine metadata for a received medical record query to identify record keepers that are likely to provide correct results for the query. These identified record keepers may be prioritized to perform the query such that results provided in response to the query may be more likely to be correct. Results received from the identified record keepers may be evaluated according to different evaluation criteria than results received from other record keepers. For example, the evaluation criteria may include various methods and processes for retrieval and analysis of records received from the various record keepers. As an example, the evaluation criteria may include prioritizing processing of the search query for identified record keepers, such that results are received from identified record keepers sooner. As another example, the evaluation criteria may process records results by indicating that results received from record keepers that are not identified record keepers are flagged as anomalous. It should be readily apparent that various methods and techniques may be employed to implement these evaluation criteria, and that the specific examples described herein should not limit the implementation in how the evaluation criteria may alter processing of medical records queries for identified record keepers as opposed to the remainder of record keepers.

The method 300 may further capture analytics related to the accuracy of results provide in response to the query to improve future query operations and generate analytics reports for record keepers. In some embodiments, the method 300 is performed by a search provider, such as the search provider 202 described above with respect to FIG. 2. The search provider 202 may be implemented as an apparatus, such as the apparatus 102 described with respect to FIG. 1.

At action 302, a medical record query is received. As described above, the medical record query may be generated by a record keeper, such as a medical provider requesting data for a particular patient. The record query may include information identifying a particular patient or group of patients, or any other data sufficient to identify one or more medical records. For example, the medical record query may include a request for all patients associated with a particular doctor, clinic, provider, insurance company, or the like, or the medical record query may identify a single patient.

At action 304, metadata for the query is identified. As described above with respect to FIG. 2, query metadata may be associated with the particular record keeper initiating the query. For example, the query metadata may include an identifier for the record keeper, a location of the record keeper, or various other data. This metadata may be used to improve the accuracy of search results provided in response to the query by identifying correlations between the metadata and search analytics associated with past searches performed for the same or similar metadata.

At action 306, the search analytics may be analyzed for past correlations with the query. For example, previous searches initiated by the same record keeper that initiated the query may be examined and analyzed to identify other record keepers that provided correct results to the past queries. In some embodiments, the search analytics may contain an entry each record keeper that has performed a query, along with entries for past record keepers that provided correct results for those queries. Each record keeper that provided a past result may also be associated with a confidence value or frequency for those correct results, so that record keepers that most frequently provided results for the querying record keeper are identified. For example, such search analytics may include data indicating that “Record keeper A frequently receives successful results from Record keepers B and C”. In some embodiments, the analytics may further include data as to metadata correlations between particular metadata and particular record keepers across multiple querying record keepers, such that the analytics are indexed by particular metadata values rather than record keepers. As an example, such search analytics might include data that states “Record keepers within 10 miles of a particular zip code tend to receive successful results from Record keepers A, B, and C.” Although the instant examples are provided with respect to plain language, it should be appreciated that such analytics may be maintained as a series of data tables, numerical values, machine learning sets, or any other form of data storage that may be reviewed, analyzed, or processed to determine correlations between medical record queries and record keepers likely to provide accurate results.

At action 308, record keepers that have been identified as likely to provide accurate results are queried for medical record results. In this manner, the method 300 may only provide the query to record keepers that have been identified as likely to provide accurate results to reduce latency experienced while the user waits for record keepers to return results. Although the instant example describes limiting processing of the query to only those record keepers identified as likely to provide successful results, various other embodiments may handle processing of the query in alternative manners. For example, identified record keepers may be queried at a higher priority (e.g., with a flag value enabled on a query message sent to the identified record keepers) such that the identified record keepers process the query faster, or record keepers not identified by the search analytics may only be queried after failing to return any valid results from the identified record keepers.

At action 310, results are received from the identified record keepers. These results may also include metadata associated with the record keeper that provided each respective result. At action 312, the results are provided to the querying record keeper as a response to the query. These results may be displayed in an interface implemented by the querying record keeper, such as a series of links associated with each of the records. In some embodiments, records that are received from record keepers other than the identified record keepers may be marked as “unlikely” or “anomalous” in the interface as a notice to the user that the records are less likely to be accurate.

At action 314, an indication of the accuracy of one or more of the results is received. As described above with respect to FIG. 2, accuracy of the result may be indicated by selection of a user of the record, or by the user selecting an interface control to indicate whether the result is correct or incorrect. The accuracy of the result may relate to whether the result corresponds to a patient identified in the query. For example, if the record is for the patient identified in the query, the result may be identified as accurate, and if the record is not for the patient identified in the query, the result may be identified as inaccurate.

At action 316, the search analytics are updated in accordance with the indication as to whether the result was accurate. In this manner, the search analytics may be provided with additional data as to whether the provided results were correct. This data may be used to identify additional correlations between record keepers, metadata, and record search results. Although the instant example describes capturing of the accuracy of particular search results, various other forms of data may also be used by the search analytics. For example, the search analytics may identify record keepers that most frequently provide results in response to queries from particular record keepers, regardless of whether those results are correct. The updated search analytics may thus be used in future search operations to refine how search queries are processed and to improve the quality and efficiency of those search operations.

At optional action 318, a report may be generated from the search analytics to provide the record keeper with information. As described above, the search analytics may be used to determine a variety of relevant information to the record keeper, such as which other providers their patients are frequently visiting. In this manner, the search analytics may be used for more than just improving search operations, as the analytic information may be useful in and of itself.

FIG. 4 is a flow diagram of another example of a method 400 for performing a medical record search in accordance with an example embodiment of the present invention. The method 400 is operable to improve medical record searching operations by flagging record results that may be anomalous or have a lower likelihood of accuracy than other results. As described above, embodiments may serve to determine a set of record keepers that are more likely to provide accurate responses to record queries than other record keepers. However, in some circumstances valid results may be received from record keepers other than the identified record keepers. As such, it may be proper to provide results from all record keepers to users to ensure that no important data is missed. However, it may be beneficial to identify some of these results as anomalous or otherwise less likely to be accurate in order to assist the user who initiated the query in analysis of the results. The method 400 may be employed by a search provider, such as the search provider 202 described with respect to FIG. 2, and implemented on an apparatus, such as the apparatus 102 described with respect to FIG. 1.

At actions 402, 404, and 406, the method 400 may proceed similarly to the method 300 and actions 302, 304, and 306 described with respect to FIG. 3, in that the method 400 may receive a medical records query, determine metadata for the query, and analyze search analytics associated with the metadata.

At action 408, the method 400 may query all record keepers using the received query. Although the method 400 is pictured without providing any prioritization or selection of record keepers using the search analytics, such additional embodiments may be employed consistent with the other embodiments described herein. At action 410, record results are received from the record keepers. As described above, these results may include metadata, such as data indicating from which record keepers each result was received.

At action 412, results from anomalous record keepers are identified. As described above, embodiments may identify particular record keepers that are more or less likely to provide results for a particular record query. Results that are received from record keepers that are less likely to provide results for the record query may be marked as anomalous. For example, if a result is received from a record keeper that historically does not provide many records to the querying record keeper, or from a record keeper that has a history of providing inaccurate record results, then the result may be marked as anomalous. At action 414, these results may be marked or otherwise flagged. At action 416, the received results may be provided to the user, with the flags remaining on any results marked as anomalous. An example of a set of results containing anomalous results is described further below with respect to FIG. 5.

FIG. 5 is a block diagram depicting a series of links 500 between a patient identity specified within a records request and one or more medical records in accordance with an example embodiment of the present invention. The links 500 include a record query 502 associated with a particular patient, “John Smith”. The patient has a date of birth of 10/6/82, and the record query 502 is associated with the “Anytown Gastroenterology” in the location, “Anytown, USA”. Although the present example depicts a request that includes data for a particular patient name and date of birth and from a particular provider, requests may also include various other data that may be used to derive a patient identity for determining record links. For example, a record or record request may include a patient driver's license number, a patient social security number, a patient insurance identifier, a patient home address, a patient telephone number, or any additional information that may be used to determine the identity of the patient.

In this example, four records 504-510 have been identified by a search provider as responsive to the record query 502. The first record 504 relates to a patient named “John Smith”, with the same date of birth, from the provider “Anytown Orthopedics.” The first result has not been identified as anomalous, so the search provider may have identified Anytown Orthopedics as likely to provide accurate results. For example, Anytown Orthopedics may have a history of provide accurate results for patients of Anytown Gastroenterology (e.g., many of the same patients may visit both providers due to geographic proximity, or the physicians at each practice may frequently refer patients to one another). Similarly, the second result 506 received from Anytown Cardiology has likewise not been flagged by the search provider.

However, the third result 508 and the fourth result 510 have been flagged as potentially “Anomalous Results.” Notably, these results 508, 510 are associated with “BigCity Regional Hospital” and “FakeVille General Hospital”. In the present example, these results may have been flagged as anomalous due to a past history of not providing results to queries from Anytown Gastroenterology (e.g., patients of Anytown Gastroenterology may choose hospitals closer to home), or these providers may have provided inaccurate records in the past (e.g., the larger hospitals may see more patients, and thus have a higher likelihood of a different patient with the same name and date of birth). Identification of anomalous results in this manner may serve to notify the user that they should examine those records carefully to ensure that the records are associated with the correct patient. In some embodiments, flagging a record as anomalous may subject the record to additional processing by a search provider to attempt to determine if the record is correct or incorrect. For example, if a record is anomalous, the search provider may prompt a user that initiated the query for additional patient data, such as an insurance identifier, the last four digits of the patient's social security number, the patient's address, or any other data that might be used to differentiate between patients with similar data. In this manner, this additional processing may be limited to cases where records are identified as potentially anomalous, thus increasing efficiency and returning accurate results faster in cases where no anomalies occur.

It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a medical records query from a first record keeper;
determining, by a processor and using a set of search analytics for previous medical records queries, one or more second record keepers from a plurality of record keepers, the one or more second record keepers identified as having an increased likelihood of returning accurate results responsive to the medical records query than a remainder of the plurality of record keepers;
processing the medical records query to identify one or more medical records associated with the plurality of record keepers; and
providing the one or more medical records to the first record keeper,
wherein medical records associated with the one or more second record keepers are evaluated according to different evaluation criteria than medical records associated with remainder of the plurality of record keepers.

2. The method of claim 1, wherein a medical record received from one of the remainder of the plurality of record keepers is flagged as an anomalous record.

3. The method of claim 2, further comprising performing additional verification of the anomalous record before providing the anomalous record to the first record keeper.

4. The method of claim 1, wherein the evaluation criteria comprise processing the medical records query by searching only medical records associated with the one or more second record keepers.

5. The method of claim 1, wherein the evaluation criteria comprise processing the medical records query by prioritizing searching the one or more second record keepers such that the medical records are provided to the first record keeper before receiving at least one medical record from one of the remainder of the plurality of record keepers.

6. The method of claim 1, further comprising:
receiving an indicator of an accuracy of at least one of the medical records; and
updating the search analytics for a record keeper that provided the at least one of the medical records in response to receiving the indicator.

7. The method of claim 1, further comprising generating a report for the first record keeper using the set of search analytics.

8. The method of claim 7, wherein the report comprises data indicating which record keepers have an increased likelihood of returning accurate results for the first record keeper.

9. The method of claim 1, wherein accurate results are results that are associated with a patient identified in the medical records query.

10. An apparatus comprising processing circuitry configured to:
receive a medical records query from a first record keeper;
determine, using a set of search analytics for previous medical records queries, one or more second record keepers from a plurality of record keepers, the one or more second record keepers identified as having an increased likelihood of returning accurate results responsive to the medical records query than a remainder of the plurality of record keepers;
process the medical records query to identify one or more medical records associated with the plurality of record keepers; and
provide the one or more medical records to the first record keeper,
wherein medical records associated with the one or more second record keepers are evaluated according to different evaluation criteria than medical records associated with remainder of the plurality of record keepers.

11. The apparatus of claim 10, wherein a medical record received from one of the remainder of the plurality of record keepers is flagged as an anomalous record.

12. The apparatus of claim 11, further comprising performing additional verification of the anomalous record before providing the anomalous record to the first record keeper.

13. The apparatus of claim 10, wherein processing the medical records query differently comprises searching only medical records associated with the one or more second record keepers.

14. The apparatus of claim 10, wherein processing the medical records query differently comprises prioritizing searching the one or more second record keepers such that the medical records are provided to the first record keeper before receiving at least one medical record from one of the remainder of the plurality of record keepers.

15. The apparatus of claim 10, wherein the apparatus is further configured to:
receive an indicator of an accuracy of at least one of the medical records; and
update the search analytics for a record keeper that provided the at least one of the medical records in response to receiving the indicator.

16. The apparatus of claim 10, wherein the apparatus is further configured to generate a report for the first record keeper using the set of search analytics.

17. The apparatus of claim 16, wherein the report comprises data indicating which record keepers have an increased likelihood of returning accurate results for the first record keeper.

18. The apparatus of claim 10, wherein accurate results are results that are associated with a patient identified in the medical records query.

19. A computer readable storage medium comprising instructions that, when executed by a processor, cause the processor to:
receive a medical records query from a first record keeper;
determine, using a set of search analytics for previous medical records queries, one or more second record keepers from a plurality of record keepers, the one or more second record keepers identified as having an increased likelihood of returning accurate results responsive to the medical records query than a remainder of the plurality of record keepers;
process the medical records query to identify one or more medical records associated with the plurality of record keepers; and
provide the one or more medical records to the first record keeper,
wherein medical records associated with the one or more second record keepers are evaluated according to different evaluation criteria than medical records associated with remainder of the plurality of record keepers.

20. The computer readable storage medium of claim 19, wherein a medical record received from one of the remainder of the plurality of record keepers is flagged as an anomalous record.
